(19) United States
(12) Patent Application Publication
(10) Pub. No.: US 2007/0058891 A1
(43) Pub. Date: Mar. 15, 2007

(54) HYDRODYNAMIC BEARING ASSEMBLY

(76) Inventors: Chien-Long Hong, Shenzhen (CN); Ching-Hsiung Huang, Shenzhen (CN); Wun-Chang Shih, Shenzhen (CN); Hsien-Sheng Pei, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,471

(22) Filed: Mar. 28, 2006

(30) Foreign Application Priority Data
Sep. 9, 2005 (CN) 200510037222.1

(51) Int. Cl. H02K 5/16; F16C 32/06

(52) U.S. Cl. 384/107; 310/90

(57) ABSTRACT

A hydrodynamic bearing assembly (10) which includes a bearing sleeve (11) defining a receiving chamber (112) therein; a bearing (15) received in the receiving chamber of the bearing sleeve; a shaft (17) rotatably disposed in the bearing; first and second lubricant retaining spaces (142, 164) disposed at ends of the bearing respectively for receiving lubricant therein; and a plurality of first and second lubricant generating grooves (171, 172) disposed in the first and second lubricant retaining spaces respectively, for guiding the lubricant at the first and second lubricant retaining spaces toward a middle portion of the shaft to generate lubricant pressure on the shaft against the bearing.

### FIELD OF THE INVENTION

The present invention relates generally to bearing assemblies, and more particularly to a bearing assembly of a hydrodynamic type.

### DESCRIPTION OF RELATED ART

Due to the ever growing demand for quiet, low-friction rotational elements with extended lifetimes, hydrodynamic bearing assemblies have become increasingly used in conventional motors such as fan motors or HDD motors.

A typical hydrodynamic bearing assembly comprises a bearing surface which defines a bearing hole, and a shaft rotatably received in the bearing hole with a bearing clearance formed between the bearing surface of the bearing and an outer surface of the shaft, this gap is filled with lubricating oil. Hydrodynamic pressure generating grooves are provided in either the bearing surface of the bearing assembly or the outer surface of the shaft. When the shaft rotates, the lubricant is driven to rotate with the shaft due to the viscosity of the lubricant. A lubricating film is thus formed in the bearing clearance by means of hydrodynamic action of the hydrodynamic pressure generating grooves, so as to support the shaft without direct contact between the shaft and the bearing surface.

In operation of the bearing assembly, the rotating shaft generates a counterforce on the surrounding lubricant which supports the shaft whilst it rotates in the bearing hole. The counterforce presses the lubricant to move toward opening ends of the bearing assembly along the hydrodynamic pressure generating grooves. This causes lubricant leakage from the bearing assembly. The leakage of the lubricant from the bearing assembly results in a failure of generation of the hydrodynamic press and an increase in abrasion between the bearing surface and the shaft. Therefore, the working life of the bearing assembly may be reduced.

For the foregoing reasons, there is a need for a hydrodynamic bearing assembly which has an improved capability of preventing the lubricant from leakage.

### SUMMARY OF INVENTION

The present invention relates to a hydrodynamic bearing assembly for a motor such as a fan motor or a HDD motor. According to a preferred embodiment of the present invention, the hydrodynamic bearing assembly includes a bearing sleeve defining a receiving chamber therein; a bearing received in the receiving chamber of the bearing sleeve; a shaft rotatably disposed in the bearing; a first and second lubricant retaining spaces disposed at ends of the bearing respectively for receiving lubricant therein; and a plurality of first and second lubricant generating grooves disposed in the first and second lubricant retaining spaces respectively, for guiding the lubricant at the first and second lubricant retaining spaces toward a middle portion of the shaft to generate lubricant pressure on the shaft against the bearing.

Other advantages and novel features of the present invention will become more apparent from the following detailed description of preferred embodiment when taken in conjunction with the accompanying drawings, in which:

### BRIEF DESCRIPTION OF DRAWINGS

FIG. 1 is an exploded, isometric view of a hydrodynamic bearing assembly according to a preferred embodiment of the present invention;

FIG. 2 is an assembled view of FIG. 1; and

FIG. 3 is a cross-sectional view of FIG. 2, taken along line III-III thereof.

### DETAILED DESCRIPTION

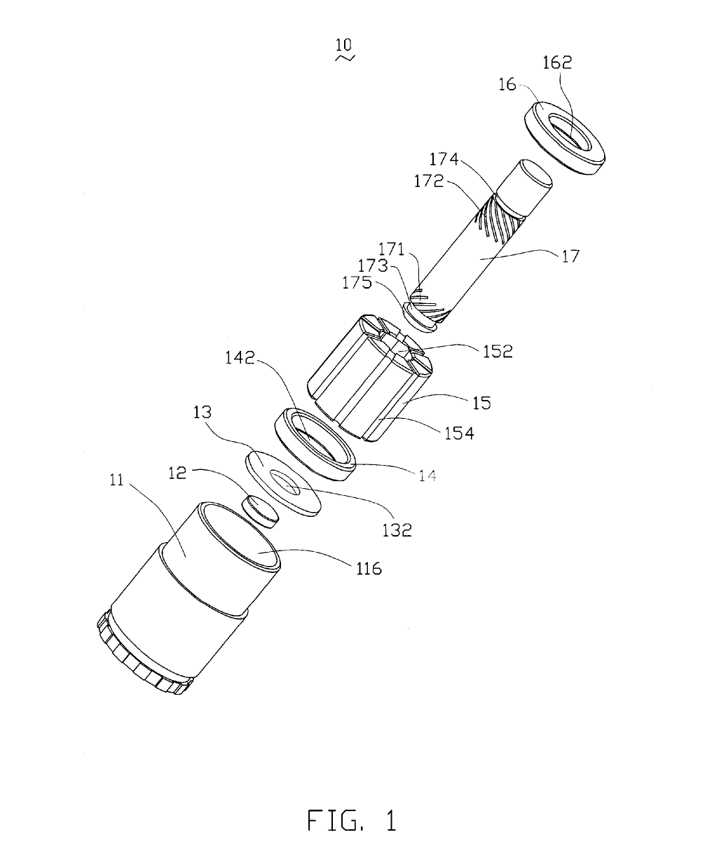

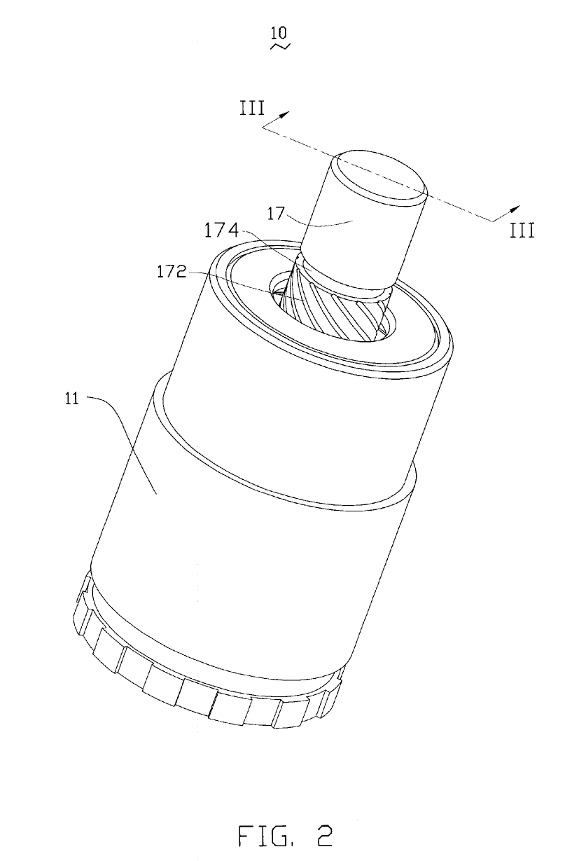

Referring to FIGS. 1 through 3, a hydrodynamic bearing assembly 10 according to a preferred embodiment of the present invention is shown. The bearing assembly 10 includes a bearing sleeve 11, a variety of components enclosed in the bearing sleeve 11, i.e., a thrust washer 12, a locking plate 13, a spacing ring 14, a ceramic hydrodynamic bearing 15, a sealing cover 16, and a shaft 17 rotatably received in a bearing hole 152 of the bearing 15.

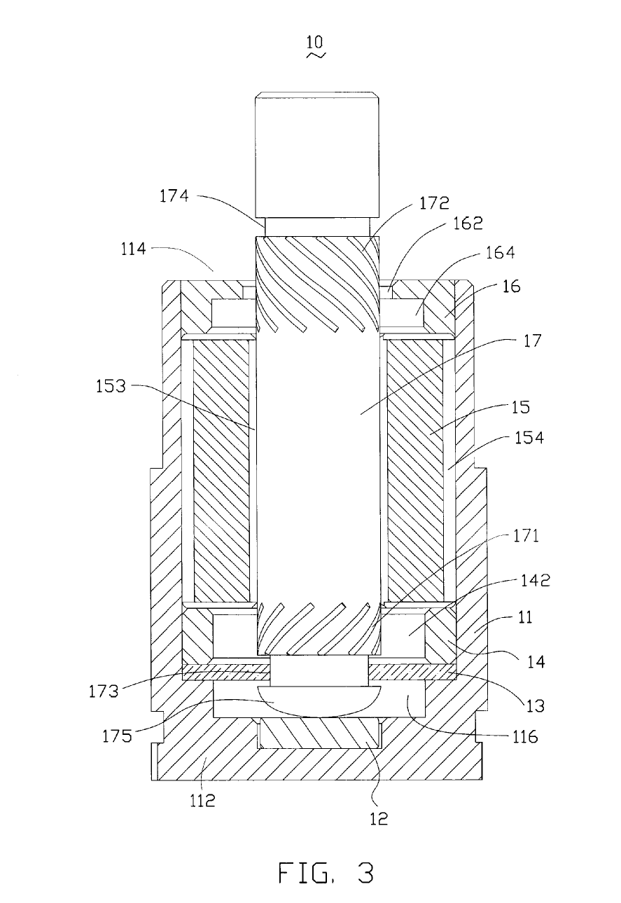

Particularly referring to FIG. 3, the bearing sleeve 11 has a generally U-shaped cross section with a bottom end thereof being closed, thereby defining a closing end 112 at the bottom end thereof and an opening end 114 at a top end thereof. A receiving chamber 116 is defined in the bearing sleeve 11 for enclosing the variety of components therein. The thrust washer 12, the locking plate 13, the spacing ring 14, the bearing 15 and the sealing cover 16 are in that order disposed in the receiving chamber 116. The shaft 17 is inserted into the bearing hole 152 of the bearing 15 after the variety of components are received in the receiving chamber 116. A bearing clearance 153 is formed between an inner surface of the bearing 15 and an outer surface of the shaft 17 for enclosing lubricant such as lubricating oil or lubricating grease therein.

The shaft 17 defines a plurality of spiral shaped first and second lubricant pressure generating grooves 171, 172 in the outer surface thereof for generation of a lubricant pressure. The first and second lubricant generating grooves 171, 172 are respectively disposed adjacent to two opposite ends of the shaft 17, and extend from the ends of the shaft 17 toward a middle portion thereof along different spinning directions. As the bearing assembly 10 is activated, the first and second lubricant generating grooves 171, 172 guide the lubricant adjacent to the ends of the shaft 17 toward the middle portion of the shaft 17, to generate the lubricating pressure which supports the shaft 17 without radial contact between the shaft 17 and the bearing 15.

The shaft 17 defines first and second annular grooves 173, 174 therein. The first and second lubricant generating grooves 171, 172 communicate with the first and second annular grooves 173, 174 respectively, at distal ends thereof which are away from the middle portion of the shaft 17. A dome-shaped supporting portion 175 is formed on the shaft 17 at a distal end adjacent to the first annular groove 173 to abut against the thrust washer 12. A rotor (not shown) such as an impeller is fixed to the shaft 17 at a distal end adjacent to the second annular groove 174, to drive the shaft 17 rotate in the bearing hole 152 of the bearing 15.

The thrust washer 12 is disposed at a bottom end of the receiving chamber 116 for axially supporting the supporting portion 175 of the shaft 17. The thrust washer 12 consists of resin material or the like which has high lubricity, so as to reduce the friction against the supporting portion 175 of the shaft 17.

The locking plate 13 defines a through hole 132 at a middle portion thereof. A diameter of the through hole 132 is greater than a diameter of the shaft 17 at the first annular groove 173, but less than a diameter of the supporting portion 175 of the shaft 17. The locking plate 13 fits with the shaft 17 at the first annular groove 173, thereby preventing the shaft 17 from axially coming off the bearing assembly 10, since if the shaft 17 is moved to separate from the bearing assembly 10, the supporting portion 175 is blocked by the locking plate 13. The locking plate 13 is made of resilient materials such as rubber or the like. Therefore, the locking plate 13 is capable of expanding outwardly to permit the supporting portion 17 of the shaft 17 passing through the through hole 132, and deforming back to its original state to engage with the shaft 17 at the first annular groove 173 as the shaft 17 at the first annular groove 173 is received in the through hole 132 of the locking plate 13.

The spacing ring 14 is annular shaped and disposed around a bottom portion of the shaft 17. A diameter of an inner hole of the spacing ring 14 is larger than a diameter of a corresponding portion of the shaft 17. A first lubricant retaining space 142 is formed among the shaft 17, the spacing ring 14 and a bottom surface of the bearing 15. One portion of the first lubricant generating grooves 171 is received in the first lubricant retaining space 142, making the portion of the first lubricant generating grooves 171 extend below the bottom end of the bearing 15. As the bearing assembly 10 is activated, the lubricant in the first lubricant retaining space 142 is driven toward the middle portion of the shaft 17 along the first lubricant generating grooves 171 for generation of the lubricant pressure.

The bearing 15 is sandwiched between the spacing ring 14 and the sealing cover 16, with the top and bottom ends of the bearing 15 respectively and intimately contact with the sealing cover 16 and the spacing ring 14. A diameter of the bearing hole 152 is greater than a diameter of the shaft 17 in the bearing hole 152, so that the bearing clearance 153 is formed therebetween. A plurality of lubricant returning grooves 154 is defined in an outer periphery wall of the bearing 15, for facilitating the lubricant at the top end of the bearing 15 to flow downwardly toward the bottom end thereof. Furthermore, the lubricant returning grooves 154 facilitate air retained in the bearing sleeve 11 to leave therefrom via the opening end 114 of the bearing sleeve 11, as the shaft 17 is inserted into the bearing hole 152 of the bearing 15.

The sealing cover 16 is disposed on the top end of the bearing 15. A step hole 162 is defined at a middle portion of the sealing cover 16 for allowing the shaft 17 to extend therethrough. The step hole 162 defines a narrower portion (not labeled) at a top end of the sealing cover 16, and a wider portion (not labeled) at a bottom end thereof. A second lubricant retaining space 164 is by the wider portion of the step hole 162 of the sealing cover 16 and among the shaft 17, the top end of the bearing 15 and the sealing cover 16. The second lubricant retaining space 164 communicates with the first lubricant retaining space 142 via the lubricant returning grooves 154. One portion of the second lubricant generating grooves 172 extends into the second lubricant retaining space 164, making the portion of the second lubricant generating grooves 172 extend above the top end of the bearing 15. The narrower portion of the step hole 162 of the sealing cover 16 spaces a small distance with the corresponding portion of the shaft 17 so as to prevent the lubricant from leakage from the bearing assembly 10 and prevent the outside dust from entering into the bearing assembly 10 which may contaminate the lubricant.

In operation of the bearing assembly 10, the lubricant in the first and second lubricant retaining spaces 142, 164 is driven with the rotating shaft 17 due to the mobility of the lubricant, and moves toward the middle portion of the shaft 17 along the first and second lubricant generating grooves 171, 172. The lubricant pressure is thus formed in the bearing clearance 153 by means of hydrodynamic action of the first and second lubricant generating grooves 171, 172, and supports the shaft 17 without radial contact between the shaft 17 and the bearing 15. Simultaneously, the rotating shaft 17 presses the lubricant at the middle portion of the shaft 17 toward the first and second lubricant retaining spaces 142, 164. The lubricant in the second lubricant retaining space 164 is partly driven to the middle portion of the shaft 17, and partly goes to the first lubricant retaining space 142 via the lubricant returning grooves 154 to meet the lubricant in the first lubricant retaining space 142. The lubricant in the first lubricant retaining space 142 is driven toward the middle portion of the shaft 17 and then pressed toward the first and second lubricant retaining spaces 142, 164 to form a circulation in the bearing assembly 10.

In the present invention, the bottom end of bearing sleeve 11 is closed, which prevents the lubricant from leakage from the closing end 112 of bearing sleeve 11. The narrower portion of the sealing cover 16 spaces a small distance with the corresponding portion of the shaft 17, which lessens the lubricant leakage from the opening end 114 of the bearing sleeve 11. Furthermore, the sealing cover 16 blocks the outside dust from entering into the bearing assembly 10, thereby preventing the inside lubricant from being contaminated by the outside dust. The lubricant returning grooves 154 benefits the lubricant in the second lubricant retaining space 164 to timely move to the first lubricant retaining space 142. So the lubricant can not be stacked in the second lubricant retaining space 164, thereby reducing the possibility of the leakage of the lubricant from the opening end 114 of bearing sleeve 11. The first and second lubricant generating grooves 171, 172 guide the lubricant in the first and second lubricant retaining space 142, 164 to move toward the middle of the shaft 17. This reduces the amount of the lubricant in the second lubricant retaining space 164, and further prevents the lubricant from leakage from the opening end 114 of the bearing sleeve 11. In addition, the lubricous thrust washer 12 reduces the friction between the shaft 17 and the bottom end of the bearing sleeve 11, thereby increasing the lifetime of the bearing assembly 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A hydrodynamic bearing assembly comprising:
a bearing sleeve defining a receiving chamber therein;
a bearing received in the receiving chamber of the bearing sleeve;
a shaft rotatably disposed in the bearing;
a first and a second lubricant retaining spaces disposed at ends of the bearing respectively for receiving lubricant therein; and
a plurality of first and second lubricant generating grooves formed in an outer surface of the shaft near two opposite ends thereof, and disposed in the first and second lubricant retaining spaces respectively, for guiding the lubricant at the first and second lubricant retaining spaces toward a middle portion of the shaft to generate lubricant pressure on the shaft against the bearing.

2. The hydrodynamic bearing assembly as described in claim 1, wherein the first and second lubricant generating grooves spirally extend from the ends of the shaft toward the middle portion thereof along different spinning directions.

3. The hydrodynamic bearing assembly as described in claim 1, further comprising a spacing member disposed adjacent to a bottom end of the receiving chamber, the first lubricant retaining space is formed between the spacing member, the shaft and a bottom end of the bearing.

4. The hydrodynamic bearing assembly as described in claim 3, wherein the spacing member is annular shaped and disposed around a bottom portion of the shaft.

5. The hydrodynamic bearing assembly as described in claim 1, wherein the shaft defines an annular groove therein, for engaging with a locking plate to lock the shaft axially on the bearing assembly.

6. The hydrodynamic bearing assembly as described in claim 5, wherein the first lubricant generating grooves communicate with the annular groove.

7. The hydrodynamic bearing assembly as described in claim 1, further comprising a sealing cover at a top end of the receiving chamber, the sealing cover defines a step hole at a middle portion thereof for allowing the shaft to pass thererthrough.

8. The hydrodynamic bearing assembly as described in claim 7, wherein the step hole defines a narrower portion at a top end of the sealing cover, and a wider portion at a bottom end thereof, and the second lubricant retaining space is defined by the wider portion of the step hole and among the shaft, the sealing cover and a top end of the bearing.

9. The hydrodynamic bearing assembly as described in claim 1, wherein the bearing defines a plurality of lubricant returning grooves in an outer periphery wall thereof, the lubricant returning grooves interlink the first lubricant retaining space with the second lubricant retaining space so as to facilitate the movement of the lubricant in the second lubricant retaining space toward the first lubricant retaining space.

10. The hydrodynamic bearing assembly as described in claim 9, wherein the bearing is made of ceramic material.

11. A hydrodynamic bearing assembly comprising:
a bearing sleeve with a bottom end thereof being closed and a top end thereof being opened;
a bearing received in the bearing sleeve;
a shaft rotatably disposed in the bearing, the shaft at the opened top end of the bearing sleeve defining a plurality of lubricant generating grooves therein, a portion of the lubricant generating grooves extending above the bearing and adjacent to the opened top end of the bearing sleeve, to guide lubricant above the bearing moving downwardly toward a middle portion of the bearing assembly; and
a sealing cover disposed at the opened top end of the bearing sleeve, the sealing cover defining a step hole therein for allowing the shaft to pass therethrough, a lubricant retaining space being formed by the step hole of the sealing cover and defined by the sealing cover, the shaft and a top end of the bearing, the portion of the lubricant generating grooves being received in the lubricant retaining space.

12. (canceled)

13. The hydrodynamic bearing assembly as described in claim 11, further comprising a spacing member disposed at a bottom end of the bearing, another lubricant retaining space being formed among the spacing member, the shaft and the bottom end of the bearing, the shaft at the another lubricant retaining space defining a plurality of other lubricant generating grooves therein.

14. The hydrodynamic bearing assembly as described in claim 13, wherein the shaft defines therein two annular grooves respectively communicating with the lubricant generating grooves and the other lubricant generating grooves adjacent to ends of the shaft.

15. The hydrodynamic bearing assembly as described in claim 13, wherein the bearing defines a plurality of lubricant returning grooves in an outer periphery wall thereof, the lubricant returning grooves interlink the lubricant retaining space with the another lubricant retaining space for facilitating the lubricant circulating in the bearing assembly.

16. The hydrodynamic bearing assembly as described in claim 13, further comprising a thrust washer between the spacing member and the closed bottom end of the bearing sleeve, the shaft having a bottom end abutting against the thrust washer, the thrust washer being made of resin material having a high lubricity.
